(19) United States
(12) Patent Application Publication
(10) Pub. No.: US 2008/0308170 A1
(43) Pub. Date: Dec. 18, 2008

(54) Air duct having flexible bellows

(75) Inventors: Allyn P. Bock, West Lafayette, IN (US); Domenic R. Albert, West Lafayette, IN (US)

Correspondence Address: Caterpillar Inc.;Intellectual Property Dept., AH 9510, 100 N.E. Adams Street, PEORIA, IL, 61629-9510, US

(73) Assignee: Caterpillar Inc., Peoria, IL (US)

(21) Appl. No.: 11/818,771

(22) Filed: Jun. 15, 2007

(51) Int. Cl. F16L 11/00

(52) U.S. Cl. 138/121; 138/109

(57) ABSTRACT

An air duct for fluidly connecting portions of an engine assembly has a first end portion and a second end portion. A bellows portion is disposed between the first end portion and the second end portion. At least one first convolution extends from the bellows portion of the air duct and has a first internal bend radius and a first straight length. At least one second convolution extends from the bellows portion of the air duct and has a second internal bend radius and a second straight length. The second convolution has at least one of the second bend radius being larger than the first bend radius and the second straight length being greater than the first straight length.

### TECHNICAL FIELD

This present disclosure relates generally to an air duct for moving air between portions of an air system and engine assembly and more particularly to an air duct having flexible bellows with an arrangement of convolutions that provide a greater degree of flexibility and tuning along the length of the air duct.

### BACKGROUND

Machines having a power source, such as an internal combustion engine, may also include various air systems to carry air to or pass air away from the power source. For example, a turbocharger or a supercharger may be provided to increase the pressure of air delivered to the engine to increase its efficiency. The charge air exiting the turbocharger or the supercharger may be cooled using a heat exchanger, or an aftercooler, before being input into the engine cylinders. These various air systems of the machine may be fluidly connected to one another or to the engine by various air ducts. To conserve space within the machine, the engine and the various air systems may be mounted within the machine in close proximity to one another. Thus, the air ducts of the air systems may extend a relatively short length between the air systems and/or engine to be fluidly connected. The relative alignment of the air systems and/or engine to be connected by the air duct may vary. Therefore, it may be desirable to be able to flex or bend at least a portion of the air duct to accommodate the relative alignment of the air systems and/or engine being fluidly connected to one another by the air duct.

One method of fluidly connecting air systems and the engine of a machine to one another is described in U.S. Pat. No. 6,056,018 (hereinafter the '018 patent) issued to Renaud. The '018 patent describes an air duct for carrying air to an engine of an automobile. The air duct includes a bellows having a plurality of convolutes that facilitate controlling the direction of the bending of the bellows. The bellows of the air duct allows for air duct deflection and decoupling for assembly, engine movements, shock absorption and NVH (noise, vibration and harshness) control.

Although the bellows of the '018 patent may provide some flexibility to the air duct, it may not be able to provide the flexibility and tunability that is desired for the air duct. Specifically, the system of the '018 patent may not provide enough flexibility to compensate for assembly misalignment, and thermal and vibratory movements in the axial, angular, and lateral directions while being strong enough to withstand the forces generated by such misalignment and movement.

The disclosed air duct is directed to overcoming one or more of the problems set forth above.

### SUMMARY OF THE DISCLOSURE

In one aspect, the present disclosure is directed towards an air duct for fluidly connecting portions of an engine assembly. The air duct has a first end portion and a second end portion. A bellows portion is disposed between the first end portion and the second end portion. At least one first convolution extends from the bellows portion of the air duct and has a first internal bend radius and a first straight length. At least one second convolution extends from the bellows portion of the air duct and has a second internal bend radius and a second straight length. The second convolution has at least one of the second bend radius being larger than the first bend radius and the second straight length being greater than the first straight length.

Another aspect is directed towards an engine assembly air duct including a bellows portion having a first end portion and a second end portion. A first convolution extends circumferentially about the first end portion. The first convolution has a first internal bend radius and a first length. A second convolution extends circumferentially about the second end portion. The second convolution has a second internal bend radius and a second length. The second convolution has at least one of the second bend radius being larger than the first bend radius and the second length being greater than the first length. The present disclosure is directed to addressing one or more of the issues set forth above.

### BRIEF DESCRIPTION OF THE DRAWINGS

FIG. 1 is an elevation view of a portion of an engine and air system having a first embodiment of an air duct in accordance with the present disclosure.

FIG. 2 is an enlarged cross-sectional view of a portion of the engine, air system, and air duct of FIG. 1 taken along the Line 2-2.

FIG. 3 is an enlarged cross-sectional view of a second embodiment of an air duct in accordance with the present disclosure.

FIG. 4 is an enlarged cross-section view of an alternate embodiment of an air duct in accordance with the present disclosure.

FIG. 5 is an enlarged cross-section view of an alternate embodiment of an air duct in accordance with the present disclosure.

### DETAILED DESCRIPTION

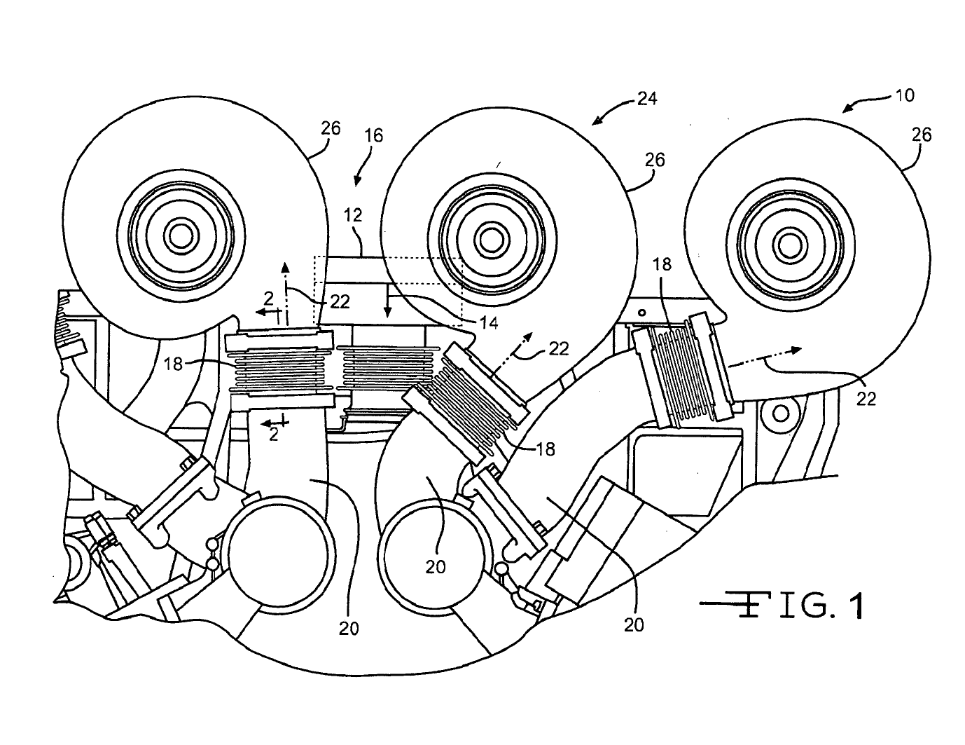

FIG. 1 illustrates an engine 10 that is configured for use on or with a machine (not shown). The machine (not shown) may embody a fixed or mobile machine that performs some type of operation associated with an industry such as mining, construction, farming, transportation, power generation, or any other utility in any industry. For example, the machine may be an earth-moving machine such as an excavator, a dozer, a loader, a backhoe, a motor grader, a dump truck, or any other earth moving machine. However, these are only examples and should not limit the scope of utility of the present disclosure.

The engine 10 may be any conventional engine, such as an internal combustion engine. The engine 10 has an inlet manifold 12 that allows a flow of compressed or pressurized combustion air, indicated by the arrow and line 14, into the engine 10 from an air induction system, shown schematically at 16. The inlet manifold 12 is fluidly connected to the air induction system 16 by a first embodiment of an air duct, indicated generally at 18. The engine 10 has at least one exhaust manifold 20 allowing a flow of exhaust gas, indicated by the arrow and lines 22, from the engine 10 to enter a combustion air induction system, indicated generally at 24. The combustion air induction system 24 includes at least one turbocharger 26. The flow of exhaust gas 20 is communicated from the at least one exhaust manifold 20 into the at least one turbocharger 26, respectively. As illustrated, each of the at least one exhaust manifolds 20 is fluidly connected to a respective one of the at least one turbochargers 26 by a corresponding air duct 18, although such a design is not required. It will be appreciated that the air duct 18 may be used to fluidly connect any portions of the engine 10, the air induction system 16, and the combustion air induction system 24, to one another or within any one or any combination of systems thereof. It will further be appreciated that the air duct 18 may be connected to the engine 10, air induction system 16, and/or combustion air induction system 24 such that the air duct 18 moves independently from these other components. It will also be appreciated that the air duct 18 may be used within any portion of the machine (not shown) to transfer fluid between any systems thereof. The engine 10, the air induction system 16, and the combustion air induction system 24 are exemplary systems in which the air duct 18 may be used. Thus, the present disclosure is not limited to use within such systems.

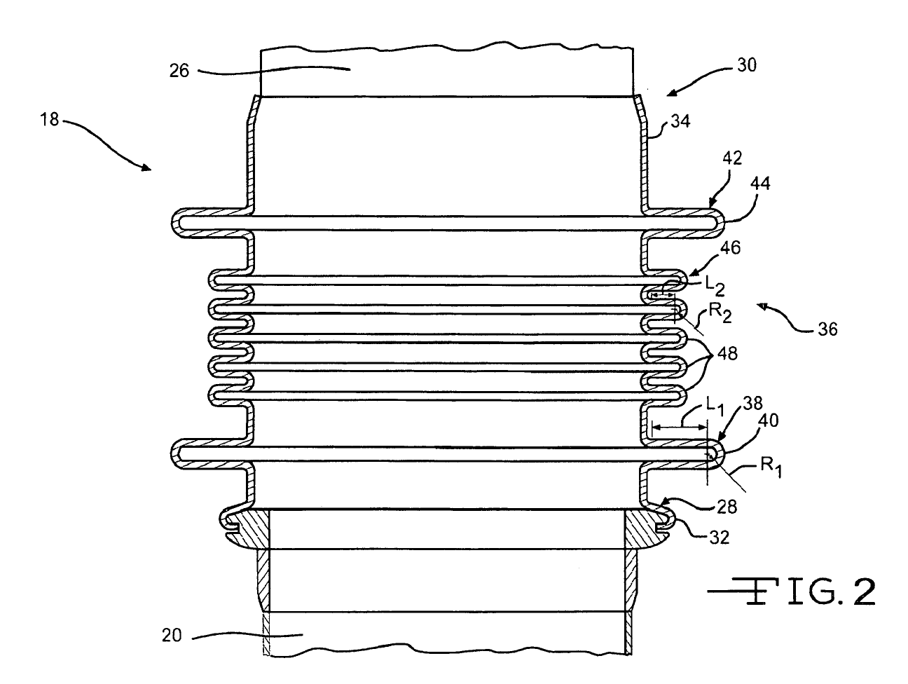

Referring now to FIG. 2, the air duct 18 includes a first end portion 28 and a second end portion 30. The first end portion 28 may have a connection portion 32 and the second end portion 30 may have a connection portion 34. The connection portions 32 and 34 may each be shaped to facilitate connection of the air duct 18 to the exhaust manifold 20 and the turbocharger 26, respectively. The connection portions 32 and 34 may be a welded V-band end connection.

Disposed between the first end portion 28 and the second end portion 30 of the air duct 18 is a bellows portion 36. The bellows portion 36 may extend along the substantial length of the air duct 18 between the first end portion 28 and the second end portion 30 as shown. It will be appreciated that the bellows portion 36 may extend along any portion of the length of the air duct 18. The bellows portion 36 includes a first end portion 38 disposed adjacent the first end portion 28 of the air duct 18. The first end portion 38 may include a convolution 40 extending circumferentially from the air duct 18. However, it will be appreciated that the first end portion 38 may include a plurality of convolutions 40. As illustrated, the convolution 40 extends outwardly from and generally perpendicular to the air duct 18. However, it will be appreciated that the convolution 40 may alternatively extend inwardly and/or may extend at an angle from the air duct 18. The bellows portion 36 includes a second end portion 42 disposed adjacent the second end portion 30 of the air duct 18. In the illustrated embodiment, the second end portion 42 may include a convolution 44 extending circumferentially from the air duct 18. However, it will be appreciated that the second end portion 42 may include a plurality of convolutions 44. As illustrated, the convolution 44 extends outwardly from and generally perpendicular to the air duct 18. However, it will be appreciated that the convolution 44 may alternatively extend inwardly and/or may extend at any angle from the air duct 18. The bellows portion 36 further includes a central portion 46 disposed between the first end portion 38 and the second end portion 42. The central portion 46 includes a plurality of convolutions 48 extending outward circumferentially from the air duct 18. It will be appreciated that the air duct 18 disclosed herein may be practiced with a single convolution, such as either the convolution 40 or the convolution 44, and that the convolution 40, 44 may be provided within any portion of the bellows portion 36 including the central portion 46. It will further be appreciated that the convolution 40, 44 can be located near or adjacent an end portion or connection portion of the air duct 18.

The convolution 40 of the first end portion 38 and the convolution 44 of the second end portion 42 may be raised circumferential ridges formed in the air duct 18. The convolution 40 and the convolution 44 each have a straight length L₁ extending from the air duct 18 and each have an internal bend radius R₁ as shown in FIG. 2. The convolutions 48 each have a straight length L₂ and each have an internal bend radius R₂. In the illustrated embodiment, the length L₁ of the convolutions 40 and 44 is longer than the length L₂ of the convolutions 48. In the illustrated embodiment, the internal bend radius R₁ of the convolutions 40 and 44 is larger than the internal bend radius R₂ of the convolutions 48.

As shown, the air duct 18 is made out of metal. Additionally, the portions of the air duct are formed integrally and the bellows portion 36 is hydraulically formed in the air duct 18. If the bellows portion 36 is hydraulically formed in the air duct 18, it is believed that the convolutions 40 and 44 may have a maximum length of approximately 40% of the internal radius of the air duct 18. However, it will be appreciated that the air duct 18 may be formed by any method and that bellows portion 36 may include convolutions with varying dimensions as described herein. Alternatively, the first end portion 28 and the second end portion 42 of the bellows portion 36 and the first end portion 28 and the second end portion 30 may be formed separately and welded to the central portion 46 of the bellow portion 36.

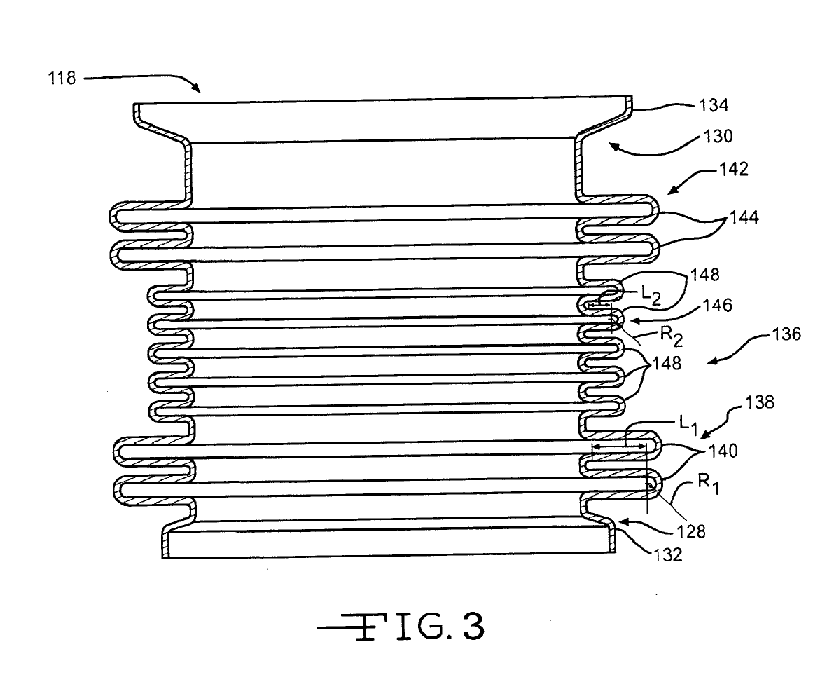

Referring now to FIG. 3, there is shown a second embodiment of an air duct, indicated generally at 118. The combustion air duct 118 is generally similar to the air duct 18 and only the differences will be explained herein. The air duct 118 includes a first end portion 128 and a second end portion 130. The first end portion 128 may have a connection portion 132 and the second end portion 130 may have a connection portion 134. The connection portions 132 and 134 may each be shaped to facilitate connection of the air duct 118 to any system of an engine.

Disposed between the first end portion 128 and the second end portion 130 of the air duct 118 is a bellows portion 136. The bellows portion 136 may extend substantially along the length of the air duct 118 between the first end portion 128 and the second end portion 130 as shown. It will be appreciated that the bellows portion 136 may extend along any portion of the length of the air duct 118. The bellows portion 136 includes a first end portion 138 disposed adjacent the first end portion 128 of the air duct 118. The first end portion 138 may include a plurality of convolutions 140 extending circumferentially from the air duct 118. The first end portion 138 may include a pair of convolutions 140. The bellows portion 136 includes a second end portion 142 disposed adjacent the second end portion 130 of the air duct 118. The second end portion 142 may include a plurality of convolutions 144 extending circumferentially outward from the air duct 118. The second end portion 142 may include a pair of convolutions 144. The bellows portion 136 further includes a central portion 146 disposed between the first end portion 138 and the second end portion 142. The central portion 146 includes a plurality of convolutions 148 extending circumferentially outward from the air duct 118.

The convolution 140 of the first end portion 138 and the convolution 144 of the second end portion 142 may be raised circumferential ridges formed in the air duct 118. The convolution 140 and the convolution 144 each have a straight length L₁ and each have an internal bend radius R₁. The convolutions 148 each have a straight length L₂ and each have an internal bend radius R₂. The length L₁ of the convolutions 140 and 144 is longer than the length L₂ of the convolutions 148. The internal bend radius R₁ of the convolutions 140 and 144 is the same as than the internal bend radius R₂ of the convolutions 148. It will be appreciated that, alternatively, the straight length L₂ of the convolutions 148 may be the same as the length L₁ of the convolutions 140 and 144 and the internal bend radius R₁ of the convolutions 140 and 144 may be larger than the internal bend radius R₂ of the convolutions 148.

### INDUSTRIAL APPLICABILITY

Air ducts are commonly used in the engine systems of machinery. For example, an air duct may carry air to an engine. The air may pass through a turbocharger, in which case the air flowing through the ducts may be heated to temperatures of up to 180 degrees Celsius, but in general the air is heated to about 140-160 degrees Celsius. The temperatures and pressures of air flowing through the ducts may vary and may be relatively high during operation of the engine.

The air ducts used to connect the various air systems of a machine must be flexible to accommodate the relative alignment of the air systems and/or engine being fluidly connected to one another by the air duct. The air ducts must also be flexible to connect the various air systems of the machine that may be mounted within the machine in close proximity to one another where the respective connections may not necessarily be precisely aligned with one another. The design of such air ducts and their respective connections to the various air systems must also accommodate assembly within the machine and withstand the stress induced by such assembly and potential assembly misalignment. Additionally, the air ducts and their respective connections should not contribute to the noise, vibration, and harshness (NVH) of the machine.

The air ducts must be strong enough to withstand assembly and operation of the engine and/or machine without deforming or elongating undesirably in the longitudinal, angular, or axial, direction under the fluctuating temperature and pressure conditions. The air ducts must be able to withstand these stresses and remain functional throughout the desired life cycle of the air duct.

The combination of large and small diameter convolutions may allow for the air ducts shown and described herein providing a greater degree of flexibility in a shorter length than is currently used in the industry. The combination of large and small internal bend radii offers one more degree of tuning for a given type of application. The longer the straight length in the larger diameter convolution, L1, and larger internal bend radius, R1, the air duct will bend more or at a greater angle than the smaller convolutions L2, having a radius R2. This may result in less stress being transferred to the metal when the bellows are subject to an external load. It should be appreciated that “tuning” the bellows by changing the lengths and radii of the convolutions of the bellows may allow for a stronger and more flexible bellows to be used that has an overall length than would conventionally be used, thereby improving the packaging of an engine exhaust system.

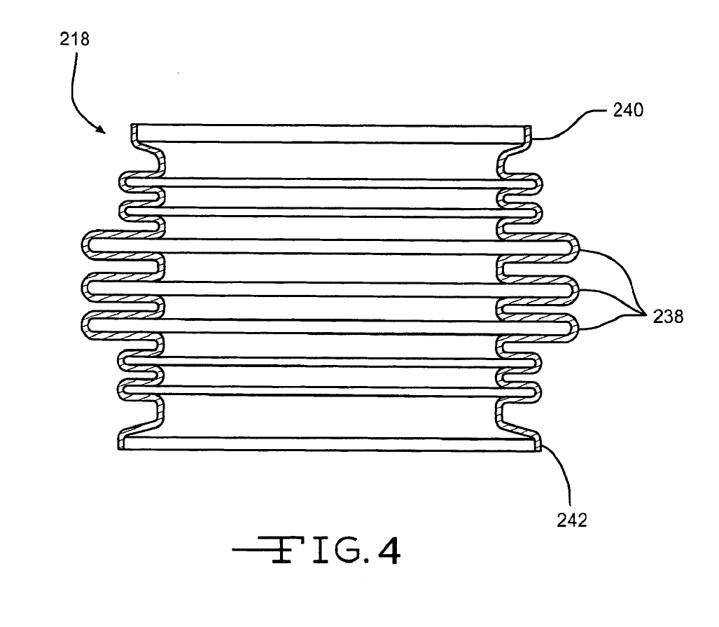

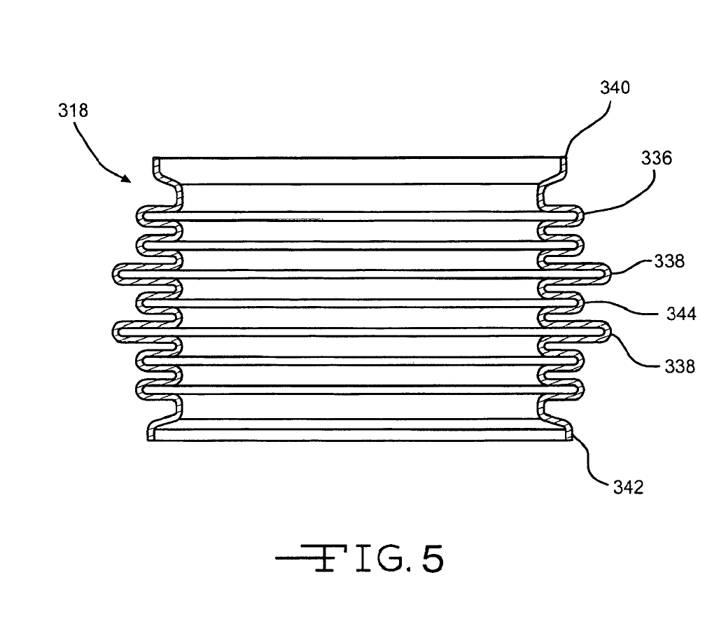

Illustrated in FIGS. 4 and 5 are alternate embodiments of air ducts according to alternate embodiments of the air ducts shown and described above. The embodiments shown in FIGS. 4 and 5 illustrate different combinations of bellows with larger and smaller diameter convolutions. As shown, the differently sized convolutions can be located along the length of the air ducts to “tune” their performance. As shown in FIG. 4, the air duct 218 includes a bellows portion 236 having a plurality of larger convolutions 238 that are distributed about a midpoint of the air duct 218 between a first end 240 and a second end 242 of the bellows portion 236.

As shown in FIG. 5, the air duct 318 includes a bellows portion 336 having a plurality of larger convolutions 338 are also distributed about a midpoint of the air duct 318 between a first end 340 and a second end 342 of the bellows portion 336. However, in this embodiment, a smaller convolution 344 is positioned at the (approximate) midpoint and between the pair of larger convolutions 338. It should be appreciated that the illustrated embodiments are examples only and that any combination of such elements can be used depending on the specific performance criteria that are desired.

Based on the foregoing it will be understood that the flexible bellows according the present disclosure may be flexible enough to provide an engine exhaust system with substantially limited leaking. This is because the bellows will be flexible enough to compensate for, and be strong enough to withstand, assembly misalignment, and thermal or vibratory movement in the axial, angular and lateral directions.

It should be understood that the above description is intended for illustrative purposes only, and is not intended to limit the scope of the present disclosure in any way. Thus, those skilled in the art will appreciate that other aspects, objects, and advantages of the disclosure can be obtained from a study of the drawings, the disclosure and the appended claims.

What is claimed is:

1. An air duct for fluidly connecting portions of an engine assembly comprising:
a first end portion and a second end portion;
a bellows portion disposed between the first end portion and the second end portion;
at least one first convolution extending from the bellows portion of the air duct and having a first internal bend radius and a first length;
at least one second convolution extending from the air duct and having a second internal bend radius and a second length, the second convolution having at least one of the second bend radius being larger than the first bend radius, and the second length being greater than the first length.

2. The air duct of claim 1 wherein at least one of the first end portion and the second end portion is respectively connected to one of an engine, an air induction system, and a combustion air induction system.

3. The air duct of claim 1 wherein at least one of the first end portion and the second end portion includes a connection portion to facilitate connection of the air duct to a portion of the engine assembly.

4. The air duct of claim 1 wherein the at least one first convolution and the at least one second convolution extend outwardly from and generally perpendicular to the air duct.

5. The air duct of claim 1 wherein the at least one first convolution comprises a plurality of convolutions.

6. The air duct of claim 1 wherein the at least one second convolution comprises a convolution disposed about the first end portion of the air duct.

7. The air duct of claim 6 wherein the at least one second convolution further comprises a convolution disposed about the second end portion of the air duct.

8. The air duct of claim 1 wherein the at least one second convolution comprises a convolution disposed approximately at a midpoint between the first end portion and the second end portion of the air duct.

9. The air duct of claim 1 wherein the at least one second convolution comprises a plurality of convolutions.

10. The air duct of claim 9 wherein the plurality of second convolutions are spaced between the first end portion and the second end portion of the air duct.

11. The air duct of claim 9 wherein the plurality of convolutions are distributed about a midpoint between the first end portion and the second end portion of the air duct.

12. The air duct of claim 1 wherein the at least one second convolution comprises two convolution disposed about the first end portion of the air duct and two convolutions disposed about the second end portion of the air duct.

13. The air duct of claim 1 wherein each of the at least one second convolution comprises a raised circumferential ridge.

14. The air duct of claim 1 wherein the at least one second convolution has a maximum length of approximately 40% of the internal radius of the air duct.

15. The air duct of claim 1 wherein the first end portion, the second end portion, the bellows portion, the at least one first convolution, and the at least one second convolution of the air duct are hydraulically formed.

16. An engine assembly air duct comprising:
a bellows portion having a first end portion and a second end portion;
a first convolution extending circumferentially about the first end portion, the first convolution having a first internal bend radius and a first length; and
a second convolution extending circumferentially about the second end portion, the second convolution having a second internal bend radius and a second length, the second convolution having at least one of the second bend radius being larger than the first bend radius and the second length being greater than the first length.
